(19) United States
(12) Patent Application Publication
(10) Pub. No.: US 2008/0204498 A1
(43) Pub. Date: Aug. 28, 2008

(54) INK-JET PRINTER

(75) Inventor: Koji HIGUCHI, Shiojiri-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 12/036,879

(22) Filed: Feb. 25, 2008

(30) Foreign Application Priority Data
Feb. 28, 2007 (JP) 2007-049337

(51) Int. Cl. B41J 29/38

(52) U.S. Cl. 347/16

(57) ABSTRACT

An ink-jet printer that prints on a second side of a print medium subsequent to printing on a first side of the print medium includes gate rollers, the inclination of the print medium with respect to a direction along which the print medium is transported being adjusted by bringing a leading portion of the print medium in the direction along which the print medium is transported into contact with a nip formed between the gate rollers such that the print medium is warped; a feed roller that feeds the print medium to the gate rollers such that the print medium comes into contact with the gate rollers and is warped; and a warpage controller that controls the amount of warpage of the print medium formed by the feed roller in accordance with a printing state of the first side of the print medium.

### BACKGROUND

1. Technical Field

The present invention relates to ink-jet printers capable of forming predetermined letters and images on print media by, for example, discharging minuscule ink droplets of a plurality of colors from a plurality of nozzles so as to form minute particles (ink dots) on the print media.

2. Related Art

Such ink-jet printers have been in widespread use by general users in addition to users in offices along with the popularization of personal computers, digital cameras, and the like since such ink-jet printers can easily produce high-quality color prints at low cost. Typical ink-jet printers of this type include printing heads (also referred to as ink-jet heads), and produce desired prints on which predetermined letters and images are formed by discharging (ejecting) ink droplets from nozzles of the ink-jet heads while the ink-jet heads are moved with respect to print media so as to form minute ink dots on the print media. In general, ink-jet printers including movable bodies referred to as carriages that include ink-jet heads attached thereto and are moved in a direction intersecting with a direction along which print media are transported (print-medium transporting direction) are referred to as “ink-jet printers of the multi-pass type”. In contrast, ink-jet printers including long ink-jet heads (not necessarily single units) extending in the direction intersecting with the print-medium transporting direction and capable of printing in a so-called one pass are referred to as “ink-jet printers of the line-head type”.

In these ink-jet printers, the inclination of print media needs to be corrected so as to be a predetermined angle. For example, when print media that are being transported are inclined with respect to the print-medium transporting direction, letters and images are not printed on the print media at proper positions. To solve this problem, for example, gate rollers described in JP-A-2004-51340 capable of correcting the inclination of print media and adjusting the timing of transporting the print media can be used. In this known technology, each print medium in a paper-feeding unit is fed by feed rollers, and brought into contact with a nip (contact portion) formed between the gate rollers. Next, the print medium is warped by further driving the feed rollers. Subsequently, the gate rollers are driven so that the warpage of the print medium is removed. With this, the inclination of the print medium is corrected and the timing of transporting the print medium is adjusted. Moreover, in this ink-jet printer, a fact that the stiffness of a print medium is changed depending on temperature and humidity is noted, and the amount of warpage of the print medium formed when the print medium is pressed toward the nip formed between the gate rollers is adjusted in accordance with temperature and humidity such that the print medium is prevented from buckling.

However, in the ink-jet printer described in JP-A-2004-51340, the amount of warpage of the print medium is adjusted simply in accordance with temperature and humidity, and, for example, the effect of ink droplets discharged to a first side of the print medium in a case where printing on a second side of the print medium is performed subsequent to printing on the first side of the print medium is not considered. In particular, when water-based ink is used, the stiffness of the print medium is significantly changed before and after printing. Similarly, the stiffness of the print medium after printing is changed in accordance with its printing state. When printing on the second side of the print medium is performed subsequent to printing on the first side, the print medium can be buckled if the print medium is not pressed toward the gate rollers with a force in accordance with the stiffness of the print medium.

### SUMMARY

An advantage of some aspects of the invention is that an ink-jet printer is provided such that a print medium whose first side is printed and whose second side is to be printed is not buckled when the print medium is pressed toward gate rollers.

According to an aspect of the invention, an ink-jet printer that prints on a second side of a print medium subsequent to printing on a first side of the print medium includes gate rollers, the inclination of the print medium with respect to a direction along which the print medium is transported being adjusted by bringing a leading portion of the print medium in the direction along which the print medium is transported into contact with a nip formed between the gate rollers such that the print medium is warped; a feed roller that feeds the print medium to the gate rollers such that the print medium comes into contact with the gate rollers and is warped; and a warpage controller that controls the amount of warpage of the print medium formed by the feed roller in accordance with a printing state of the first side of the print medium.

The warpage controller can set the amount of warpage of the print medium formed by the feed roller so as to be less than a reference value in accordance with the amount of ink droplets discharged to the first side of the print medium.

The warpage controller can set the amount of warpage of the print medium formed by the feed roller so as to be less than a reference value when the first side of the print medium is printed in color. Moreover, the warpage controller can set the amount of warpage of the print medium formed by the feed roller so as to be less than a reference value in accordance with the amount of a margin left on the first side of the print medium.

The warpage controller can set the amount of warpage of the print medium formed by the feed roller so as to be less than a reference value when the amount of ink droplets discharged to the leading portion of the first side of the print medium in the direction along which the print medium is transported is larger than that discharged to a trailing portion of the print medium in the direction along which the print medium is transported.

According to an aspect of the invention, the print medium is prevented from buckling when the print medium is pressed toward the gate rollers by setting the amount of warpage of the print medium formed by the feed roller to a value smaller than a reference value when, for example, the amount of ink droplets discharged to the first side of the print medium is large, the first side of the print medium is printed in color, the amount of the margin left on the first side of the print medium is small, and the amount of ink droplets discharged to the leading portion of the first side of the print medium in the direction along which the print medium is transported is larger than that discharged to the trailing portion of the print medium in the direction along which the print medium is transported.

### BRIEF DESCRIPTION OF THE DRAWINGS

The invention will be described with reference to the accompanying drawings, wherein like numbers reference like elements.

FIG. 1 is a front view schematically illustrating an ink-jet printer according to a first embodiment of the invention.

FIGS. 2A and 2B illustrate a part adjacent to gate rollers in the ink-jet printer shown in FIG. 1 in detail.

FIGS. 3A to 3E illustrate how to control amounts of warpage of one-side-printed media in the ink-jet printer shown in FIG. 1.

FIG. 4 is a flow chart illustrating an arithmetic processing for calculating an amount of warpage of a one-side-printed medium in the ink-jet printer shown in FIG. 1.

### DESCRIPTION OF EXEMPLARY EMBODIMENTS

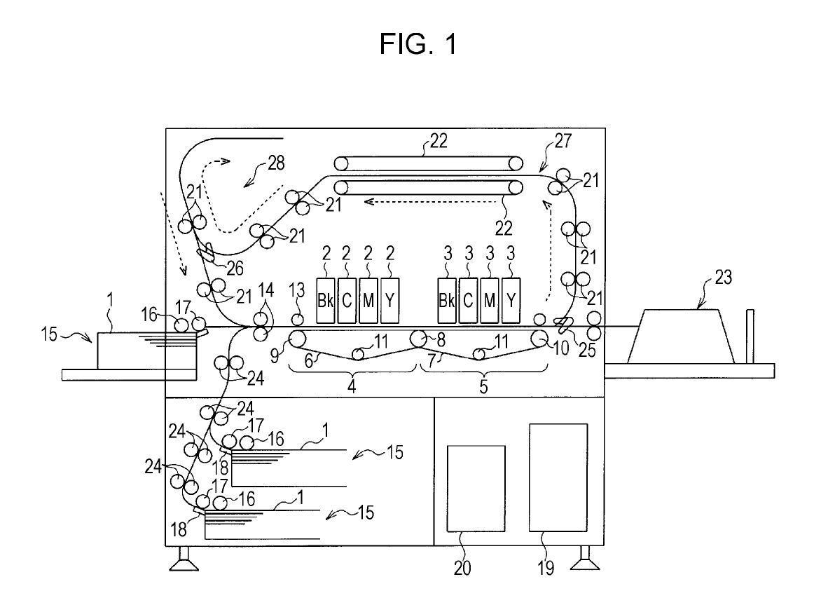

Next, an ink-jet printer according to a first embodiment of the invention will be described with reference to the drawings. FIG. 1 is a front view schematically illustrating the ink-jet printer of the line-head type according to this embodiment. In FIG. 1, each print medium 1 is transported from left to right, and letters and images are printed on the print media 1 in printing areas on the transporting path of the print media 1. The ink-jet printer according to this embodiment includes ink-jet heads disposed at two different positions in a direction along which the print media 1 are transported (hereinafter referred to as a print-medium transporting direction). In addition, the ink-jet printer includes a reversing unit at an upper position in the printer so as to reverse the print media and supply the reversed print media to the printing areas. With this, the ink-jet printer is capable of so-called duplex printing.

As shown in FIG. 1, the ink-jet printer includes first ink-jet heads 2 disposed upstream in the print-medium transporting direction, second ink-jet heads 3 disposed downstream in the print-medium transporting direction, a first transporting unit 4 disposed below the first ink-jet heads 2 so as to transport the print media 1, and a second transporting unit 5 disposed below the second ink-jet heads 3. The first transporting unit 4 includes a plurality of first transporting belts 6 disposed at predetermined intervals in a direction intersecting with the print-medium transporting direction (hereinafter referred to as a nozzle-array direction). Similarly, the second transporting unit 5 includes a plurality of second transporting belts 7 disposed at predetermined intervals in the nozzle-array direction.

The transporting belts 6 and 7 are alternately disposed. A driving roller 8 is disposed at a position where the transporting belts 6 and 7 overlap each other. A first driven roller 9 is disposed upstream of the driving roller 8, and a second driven roller 10 is disposed downstream of the driving roller 8. A tension roller 11 is disposed at a lower intermediate position between the driving roller 8 and the first driven roller 9, and another tension roller 11 is disposed at a lower intermediate position between the driving roller 8 and the second driven roller 10. The first transporting belts 6 are wound around the driving roller 8, the first driven roller 9, and one of the tension rollers 11; and the second transporting belts 7 are wound around the driving roller 8, the second driven roller 10, and the other tension roller 11. A motor (not shown) is connected to the driving roller 8. When the driving roller 8 is rotated by the motor, the first transporting unit 4 constituted by the first transporting belts 6 and the second transporting unit 5 constituted by the second transporting belts 7 are synchronously driven at the same speed. In addition, a paper-pressing roller 13 is disposed above the first driven roller 9 such that the print media 1 electrostatically adhere to the first transporting belts 6.

The ink-jet heads 2 and 3 for, for example, four colors of yellow (Y), magenta (M), cyan (C), and black (K) are disposed at different positions in the print-medium transporting direction. Ink is supplied from ink tanks (not shown) for those colors to the ink-jet heads 2 and 3 via ink-supplying tubes. A plurality of nozzles are formed in the ink-jet heads 2 and 3 in the nozzle-array direction, and minute ink dots are formed on the print media 1 when required amounts of ink droplets are discharged from the nozzles to desired positions on the print media 1 at the same time. Letters and images can be printed on first sides of the print media 1 in a so-called one pass when the above-described operation is performed for each color while the print media 1 pass under the ink-jet heads 2 and 3 using the transporting units 4 and 5 only one time. That is, the areas in which the ink-jet heads 2 and 3 are arranged correspond to the printing areas.

Ink can be discharged from the nozzles of the ink-jet heads using, for example, the electrostatic effect, the piezoelectric effect, or film boiling. In the method using the electrostatic effect, driving signals are supplied to electrostatic gaps serving as actuators such that the positions of vibrating plates inside cavities are changed. With this, the pressure inside the cavities is changed, and ink droplets are discharged from nozzles in response to the pressure change. In the method using the piezoelectric effect, driving signals are supplied to piezoelectric elements serving as actuators such that the positions of vibrating plates inside cavities are changed. With this, the pressure inside the cavities is changed, and ink droplets are discharged from nozzles in response to the pressure change. In the method using film boiling, minute heaters disposed inside cavities instantaneously heat ink to 300° C. or more such that film boiling occurs and bubbles are generated. With this, the pressure inside the cavities is changed, and ink droplets are discharged from nozzles in response to the pressure change. Any of these ink-discharging methods is applicable to the invention. However, the method using the piezoelectric effect is preferably used since the amounts of ink droplets to be discharged can be adjusted by changing peak values of the driving signals or changing the degree of increments or decrements of voltage.

The ink-discharging nozzles of the first ink-jet heads 2 are disposed only between two adjacent first transporting belts 6 in the first transporting unit 4, and the ink-discharging nozzles of the second ink-jet heads 3 are disposed only between two adjacent second transporting belts 7 in the second transporting unit 5. With this, the ink-jet heads 2 and 3 can be cleaned by cleaning units that are disposed inside the transporting belts 6 and 7 and are vertically movable to the ink-jet heads 2 and 3. With this arrangement, a whole page cannot be printed in one pass using only either of the ink-jet heads 2 and 3. Therefore, the ink-jet heads 2 and 3 are disposed at different positions in the print-medium transporting direction so that the printing areas compensate for each other.

A pair of gate rollers 14 is disposed upstream of the first driven roller 9. The gate rollers 14 adjust the timing of feeding the print media 1 supplied from paper-feeding units 15, and correct the inclination of the print media 1 with respect to the print-medium transporting direction. In this embodiment, the paper-feeding units 15 are disposed at three positions in the printer so as to support the print media 1 of different sizes. Moreover, a pickup roller 16 is disposed over each of the paper-feeding units 15 so as to supply the print media 1. A separation roller 17 is disposed at each connecting point of the paper-feeding units 15 and the transporting paths of the print media 1, and a separation pad 18 is disposed under each of the separation rollers 17.

The ink-jet printer according to this embodiment further includes a controller 19 for controlling the printer and a power source 20 at a lower right position in FIG. 1. The controller 19 includes a computer system including, for example, a central processing unit (CPU). The power source 20 controls its electric power and generates a high voltage to be supplied to a belt-charging unit (not shown). In this embodiment, the transporting belts 6 and 7 are charged by the belt-charging unit so that the print media 1 adhere to the charged transporting belts 6 and 7 by electrostatic force while being transported.

In this ink-jet printer, the surfaces of the transporting belts 6 and 7 are charged by the belt-charging unit. While the transporting belts 6 and 7 are charged, the print media 1 are fed via the gate rollers 14 onto the first transporting belts 6 one by one. When the print media 1 are pressed to the first transporting belts 6 by the paper-pressing roller 13, the print media 1 adhere to the surfaces of the first transporting belts 6 by dielectric polarization effect caused in the print media 1 by the charged first transporting belts 6. In this state, the driving roller 8 is rotated by the motor, and the driving force is transmitted to the first driven roller 9 via the first transporting belts 6.

The print media 1 are moved downstream in the print-medium transporting direction to a position below the first ink-jet heads 2 while adhering to the first transporting belts 6. Subsequently, ink droplets are discharged from the nozzles formed in the first ink-jet heads 2. After printing using the first ink-jet heads 2, the print media 1 are moved downstream in the print-medium transporting direction, and transferred to the second transporting belts 7 in the second transporting unit 5. Since the surfaces of the second transporting belts 7 are also charged by the belt-charging unit as described above, the print media 1 adhere to the surfaces of the second transporting belts 7 by the dielectric polarization effect in the same manner as the print media 1 adhere to the first transporting belts 6.

In this state, the print media 1 are moved downstream in the print-medium transporting direction by the second transporting belts 7 to a position below the second ink-jet heads 3. Subsequently, ink droplets are discharged from the nozzles formed in the second ink-jet heads 3. After printing using the second ink-jet heads 3, the print media 1 are further moved downstream in the print-medium transporting direction, and discharged to a paper-discharging section 23 while the print media 1 are separated from the surfaces of the second transporting belts 7 by a separating unit (not shown). Herein, guide rollers 24 shown in FIG. 1 feed the print media 1 from the paper-feeding units 15 to the first transporting unit 4, and guiding paths (not shown) for substantially guiding the print media 1 are formed adjacent to the guide rollers 24.

As described above, the reversing unit for reversing the print media 1 is disposed above the printing areas formed over the transporting units 4 and 5. The reversing unit includes a plurality of feed rollers 21, belt conveyors 22 that transport the print media 1 while vertically supporting the print media 1, a transporting section 27 that transports the print media 1 from a position adjacent to the paper-discharging section 23 to a position adjacent to the paper-feeding units 15 via a guiding path (not shown), and a reversing section 28 that takes the print media 1 out of the transporting section 27 at a predetermined position of the transporting section 27 and reveres the print media 1. A first flapper 25 for sending the print media 1 whose first sides are printed to the transporting section 27 is disposed upstream of the paper-discharging section 23 in the print-medium transporting direction, and a second flapper 26 for sending the print media 1 from the transporting section 27 to the reversing section 28 is disposed below the reversing section 28.

For duplex printing, the print media 1 whose first sides are printed in the printing areas are sent to the transporting section 27 by the first flapper 25, and transported to the reversing section 28 by the feed rollers 21 in the transporting section 27 and the belt conveyors 22. When the print media 1 are transported to a position before the reversing section 28, the second flapper 26 is actuated, and sends the print media 1 to the reversing section 28. The reversing section 28 guides the print media 1 using the feed rollers 21 such that the print media 1 are turned upside down, and sends the print media 1 back using the feed rollers 21 while the print media 1 are in the inverted position. The print media 1 pass through the second flapper 26, and are sent to the gate rollers 14 through the feed rollers 21 adjacent to the paper-feeding units 15. The gate rollers 14 adjust the inclination of the print media 1 whose first sides are printed in the same manner as the gate rollers 14 adjust the inclination of the print media 1 whose first sides are unprinted, and feed the print media 1 to the printing areas.

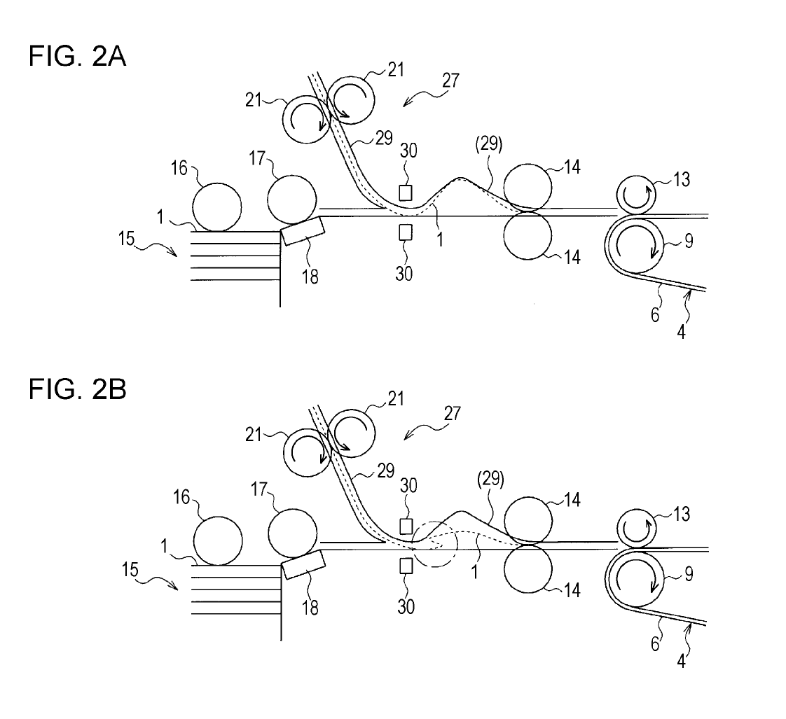

FIGS. 2A and 2B illustrate a print medium 1 fed from the transporting section 27 to the gate rollers 14 in detail. A guide plate 29 shown in FIGS. 2A and 2B forms the guiding path of the transporting section 27, and guides the print medium 1 when the print medium 1 is pressed toward the gate rollers 14 by the feed rollers 21 and warped. In addition, detection sensors 30 shown in FIGS. 2A and 2B detect the passage of the print medium 1. When the stiffness of the print medium 1 is high to some extent, the print medium 1 pressed toward the gate rollers 14 is warped flexibly as shown in FIG. 2A, and the inclination of the print medium 1 can be adjusted when the warpage of the print media 1 is removed. In contrast, when the stiffness of the print medium 1 is low, the print medium 1 pressed toward the gate rollers 14 can be buckled and form, for example, a Z shape as shown in FIG. 2B. In particular, when the first side of the print medium 1 is printed using water-based ink, the stiffness of the print medium 1 is further reduced due to the penetration of the water-based ink.

In this embodiment, print media 1, whose first sides are printed and whose second sides are to be printed (hereinafter also referred to as one-side-printed media 1) are warped when being pressed toward the gate rollers 14, and the amounts of warpage are controlled by the controller 19. The amounts of warpage of the print media 1 can be controlled using amounts of feed, that is, amounts of rotation of the feed rollers 21 that are closest to the detection sensors 30 after the detection sensors 30 detect the one-side-printed media 1. Since the stiffnesses of the print media 1 are not significantly high, the amounts of warpage of the print media 1 can be adjusted by controlling the amounts of feed, i.e., the amounts of rotation of the feed rollers 21 without controlling the pushing force with which the print media 1 are pressed toward the gate rollers 14. Reductions in the amounts of warpage can easily prevent the buckling of the print media 1. However, the warpage is required to some extent so that the inclination of the print media 1 can be adjusted. Therefore, the controller 19 performs control such that the amounts of warpage become small when the stiffnesses of the one-side-printed media 1 are low in particular.

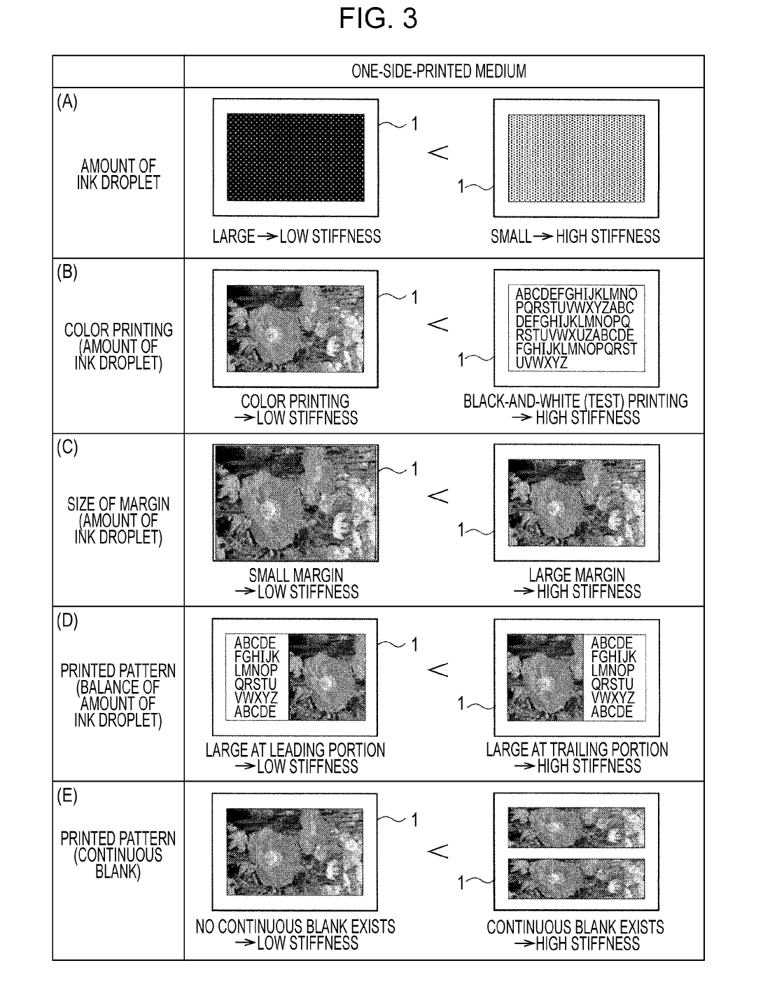

In this embodiment, the stiffnesses of the one-side-printed media 1 and the amounts of warpage of the one-side-printed media 1 are determined as follows. Herein, one-side-printed media 1 shown in FIGS. 3A to 3E are transported from left to right in FIG. 3A to 3E. For example, as shown in FIG. 3A, when the amounts (total amounts) of ink droplets discharged to the first sides of the print media 1 are determined as large, the stiffnesses of the print media 1 are determined as low, and warpage correction factors for the print media 1 are set to small values. Moreover, as shown in FIG. 3B, the amounts of ink droplets discharged to the first sides of the print media 1 are determined as large in the case of color printing, and the stiffnesses of the print media 1 are determined as low. Thus, the warpage correction factors are set to small values. Furthermore, as shown in FIG. 3C, the amounts of ink droplets discharged to the first sides of the print media 1 are determined as large when margins are small, and the stiffnesses of the print media 1 are determined as low. Thus, the warpage correction factors are set to small values. In the case of color printing, the amounts of ink droplets are increased compared with the case of black-and-white printing since ink droplets of different colors are discharged to the same positions.

In this embodiment, the stiffnesses of one-side-printed media 1 are determined also using patterns printed on the first sides of the print media 1 for determining the amounts of warpage. As shown in FIG. 3D, for example, even when the amounts of ink droplets discharged to the one-side-printed media 1 are the same, the stiffnesses of the print media 1 are determined as low when large amounts of ink droplets are discharged to the leading portions of the print media 1 in the print-medium transporting direction, which correspond to areas to be buckled, compared with the case where large amount of ink droplets are discharged to the trailing portions of the print media 1 in the print-medium transporting direction, which correspond to areas uninvolved in buckling. Thus, the warpage correction factors are set to small value. Moreover, when no continuous blank spaces are formed in the print-medium transporting direction, the stiffnesses of the print media 1 are determined to be low compared with the case where continuous blank spaces are formed in the print-medium transporting direction, and the warpage correction factors are set to small values. Aside from these, the warpage correction factors are also determined with consideration of the types of the print media 1. The amounts of warpage of the one-side-printed media 1 are calculated by multiplying a reference value of the amounts of warpage by the above-described warpage correction factors.

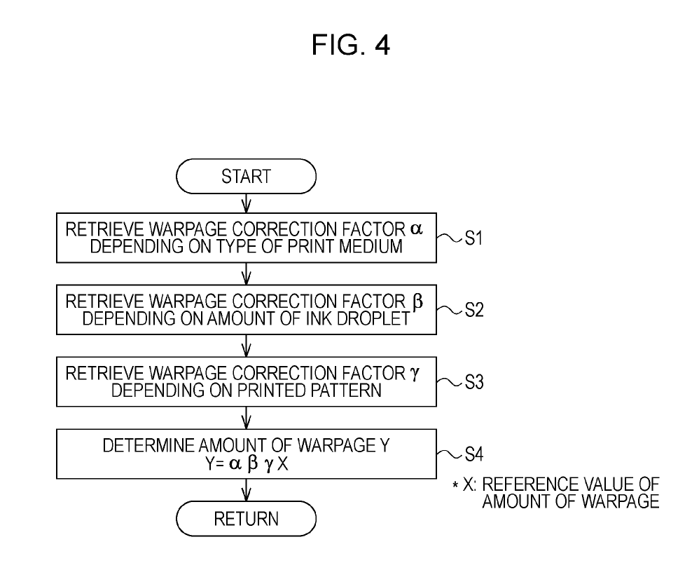

FIG. 4 illustrates an arithmetic processing for calculating an amount of warpage of a one-side-printed medium 1. In Step S1, a warpage correction factor α depending on the type of the one-side-printed medium 1 described above is retrieved from a memory containing warpage correction factors. In Step S2, a warpage correction factor β depending on the amount (total amount) of ink droplets described above is retrieved from the memory. In Step S3, a warpage correction factor γ depending on the printed pattern described above is retrieved from the memory. In Step S4, an amount of warpage Y is calculated by multiplying a reference value X of the amount of warpage by the warpage correction factors α to γ retrieved in Steps S1 to S3. Subsequently, the process returns to the main program.

In accordance with the ink-jet printer according to this embodiment, one-side-printed media 1, whose first sides are printed and whose second sides are to be printed, are warped when being pressed toward the gate rollers 14 by the feed rollers 21, and the amounts of warpage are controlled in accordance with the amounts of ink droplets discharged to the first sides of the one-side-printed media 1, the printing states such as the patterns printed on the one-side-printed media 1, and the like. Therefore, the one-side-printed media 1 can be prevented from buckling when the one-side-printed media 1 are pressed toward the gate rollers 14.

Moreover, the amounts of warpage of the one-side-printed media 1 are set so as to be less than the reference value in accordance with the amounts of ink droplets discharged to the first sides of the one-side-printed media 1. Therefore, the one-side-printed media 1 can be prevented from buckling when the one-side-printed media 1 are pressed toward the gate rollers 14 by the feed rollers 21. Furthermore, the amounts of warpage of the one-side-printed media 1 are set so as to be less than the reference value in the case of color printing. Therefore, the one-side-printed media 1 can be reliably prevented from buckling when the one-side-printed media 1 are pressed toward the gate rollers 14 by the feed rollers 21.

Moreover, the amounts of warpage of the one-side-printed media 1 are set so as to be less than the reference value in accordance with the amounts of blank spaces formed on the first sides of the one-side-printed media 1. Therefore, the one-side-printed media 1 can be reliably prevented from buckling when the one-side-printed media 1 are pressed toward the gate rollers 14 by the feed rollers 21. Furthermore, the amounts of warpage of the one-side-printed media 1 are set so as to be less than the reference value when the amounts of ink droplets discharged to the leading portions of the one-side-printed media 1 in the print-medium transporting direction are larger than those discharged to the trailing portions of the one-side-printed media 1. Therefore, the one-side-printed media 1 can be reliably prevented from buckling when the one-side-printed media 1 are pressed toward the gate rollers 14 by the feed rollers 21. In addition, the amounts of warpage of the one-side-printed media 1 are set so as to be less than the reference value when the areas of continuous blank spaces formed on the first sides of the one-side-printed media 1 in the print-medium transporting direction are small. Therefore, the one-side-printed media 1 can be reliably prevented from buckling when the one-side-printed media 1 are pressed toward the gate rollers 14 by the feed rollers 21.

What is claimed is:

1. An ink-jet printer, printing on a second side of a print medium subsequent to printing on a first side of the print medium, comprising:
gate rollers, the inclination of the print medium with respect to a direction along which the print medium is transported being adjusted by bringing a leading portion of the print medium in the direction along which the print medium is transported into contact with a nip formed between the gate rollers such that the print medium is warped;
a feed roller that feeds the print medium to the gate rollers such that the print medium comes into contact with the gate rollers and is warped; and
a warpage controller that controls the amount of warpage of the print medium formed by the feed roller in accordance with a printing state of the first side of the print medium.

2. The ink-jet printer according to claim 1, wherein the warpage controller sets the amount of warpage of the print medium formed by the feed roller so as to be less than a reference value in accordance with the amount of ink droplets discharged to the first side of the print medium.

3. The ink-jet printer according to claim 1, wherein the warpage controller sets the amount of warpage of the print medium formed by the feed roller so as to be less than a reference value when the first side of the print medium is printed in color.

4. The ink-jet printer according to claim 1, wherein the warpage controller sets the amount of warpage of the print medium formed by the feed roller so as to be less than a reference value in accordance with the amount of a margin left on the first side of the print medium.

5. The ink-jet printer according to claim 1, wherein the warpage controller sets the amount of warpage of the print medium formed by the feed roller so as to be less than a reference value when the amount of ink droplets discharged to the leading portion of the first side of the print medium in the direction along which the print medium is transported is larger than the amount of ink droplets discharged to a trailing portion of the print medium in the direction along which the print medium is transported.
